(19) United States
(12) Patent Application Publication
(10) Pub. No.: US 2008/0277396 A1
(43) Pub. Date: Nov. 13, 2008

(54) DISPENSING DEVICE FOR A WASHING AND/OR RINSING AGENT, IN PARTICULAR FOR A DISH-WASHING MACHINE, AND PROVIDED WITH AN IMPROVED MECHANISM FOR MANUAL OPENING

(75) Inventor: Giuseppe MARONE, Nichelino (Torino) (IT)

Correspondence Address: SUGHRUE MION, PLLC, 2100 PENNSYLVANIA AVENUE, N.W., SUITE 800, WASHINGTON, DC, 20037, US

(73) Assignee: ELBI INTERNATIONAL S.p.A., Torino (IT)

(21) Appl. No.: 12/112,424

(22) Filed: Apr. 30, 2008

(30) Foreign Application Priority Data
May 9, 2007 (IT) TO2007U000062

(51) Int. Cl. B65D 43/26; B67D 5/06; B08B 3/00

(52) U.S. Cl. 220/262; 222/144.5; 134/56 D

(57) ABSTRACT

The dispensing device for a washing and/or rinsing agent, in particular for a dishwashing machine, comprises:
a stationary body designed to be integrally connected to the door of the dishwashing machine on the side directed during operation towards the washing chamber;
a receptacle formed in the stationary body for receiving a quantity of a washing/rinsing agent and having a respective mouth; and
a movable lid associated with the receptacle and displaceable in a manner constrained to the stationary body against the action of resilient return means from an open position into a closed position, where it opens and closes the mouth, respectively.

The dispensing device also includes a manual opening mechanism for the movable lid, which comprises
a retaining apparatus able to assume an activated configuration, in which it is designed to lock the movable lid in the closed position, and a deactivated configuration, in which it is able to free the movable lid, allowing it to pass from the closed position into the open position; and
an operating member of the monostable type located on the side of the stationary body which during operation of the dishwashing machine is directed upwards and displaceable against the action of first resilient recall means from a stable extracted position into an unstable retracted position, in which positions the operating member arranges the associated retaining apparatus in the activated configuration and in the deactivated configuration, respectively.

The present invention relates to a dispensing device for a washing and/or rinsing agent for a dishwashing machine.

More specifically the invention relates to a dispensing device according to the preamble of the accompanying claim 1.

This type of dispensing device has a number of drawbacks.

One drawback consists in the fact that the mechanism for manually opening the lid which protects the opening for introduction of the washing/rinsing agent is generally situated in the swing door of the dishwashing machine in positions which cannot be easily accessed by a user. In particular, the current designs of these mechanisms are such that the user must swing open completely the door of the dishwashing machine in order to be able to open the lid and perform filling of the dispensing device before starting the washing cycle.

One object of the present invention is to provide a dispensing device which is able to solve this drawback together with others of the known art, which is operationally reliable and which at the same time may be produced in a simple and low-cost manner.

This object, together with others, are achieved according to the present invention by means of a dispensing device of the type specified above and further defined by the characterizing part of the accompanying claim 1.

Further characteristic features and advantages of the invention will become clear from the following detailed description provided purely by way of a non-limiting example with reference to the accompanying drawings in which:

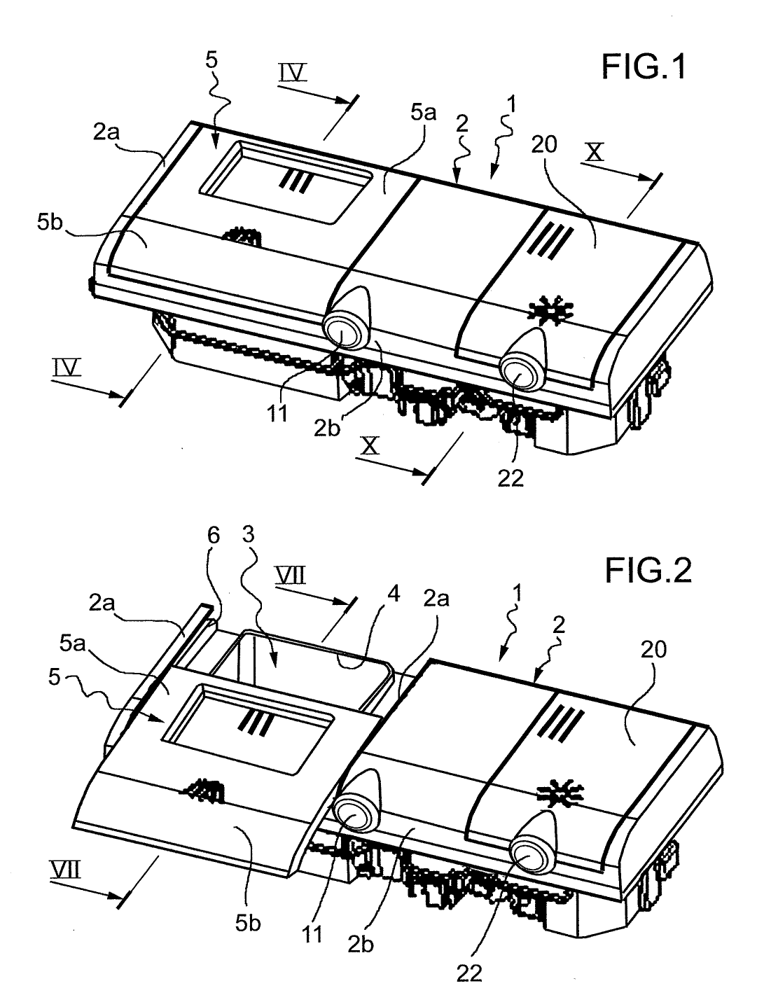

FIG. 1 is a perspective view of a possible embodiment of a dispensing device according to the invention with the lid for the washing agent shown in the closed position;

FIG. 2 is a perspective view similar to that of FIG. 1, but with the lid for the washing agent shown in the open position;

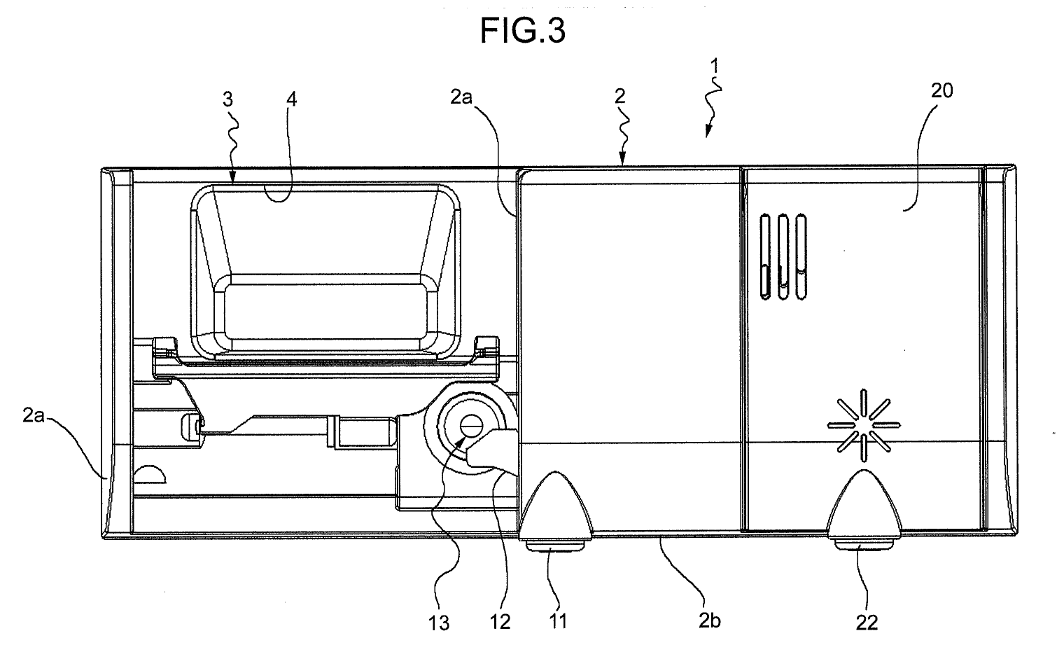

FIG. 3 is a top plan view of the dispensing device shown in the preceding figures, but without the lid for the washing agent;

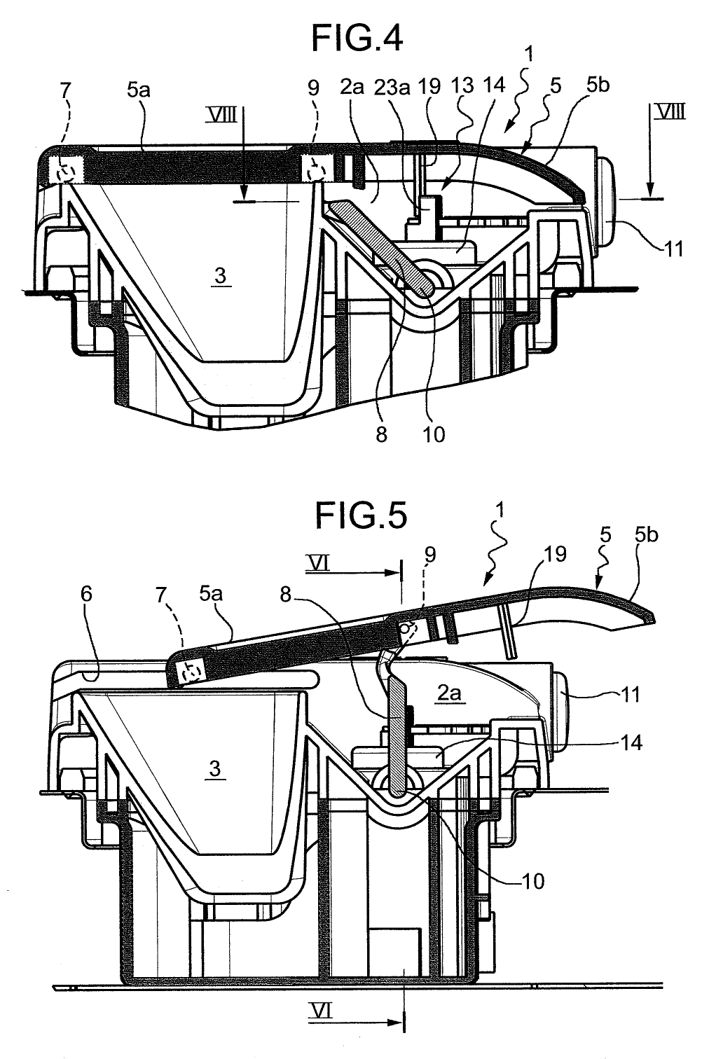

FIG. 4 is a cross-sectional view of the dispensing device along the line IV-IV shown in FIG. 1;

FIG. 5 is a view similar to that of FIG. 4, but which shows the lid for the washing agent in a partially open position;

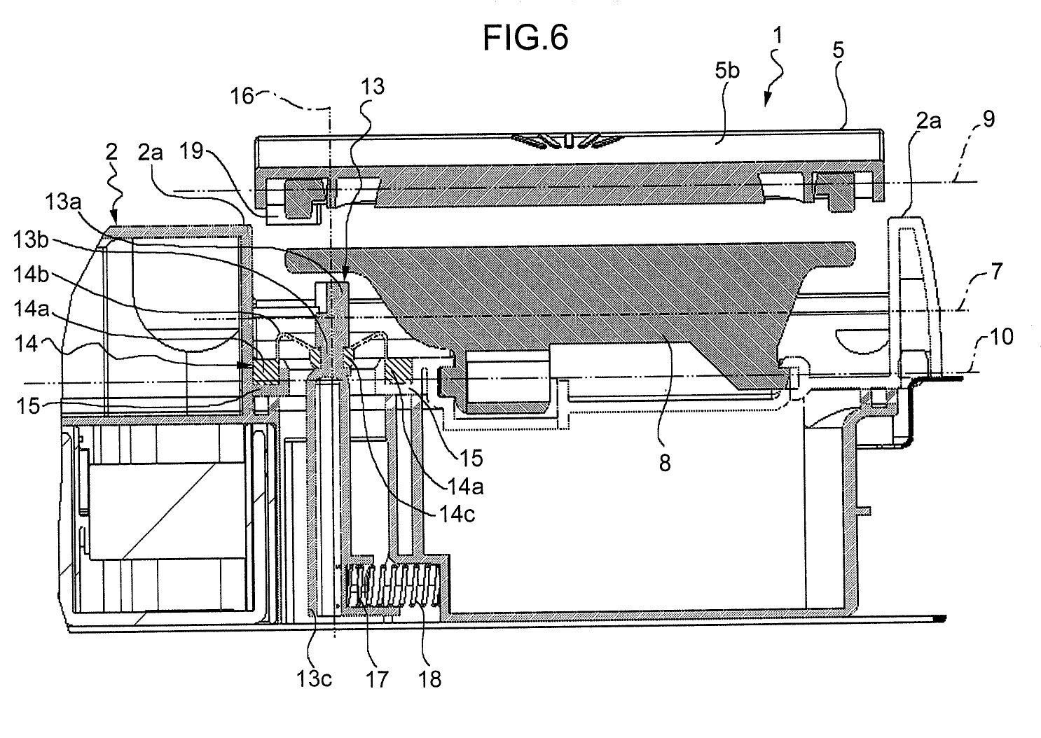

FIG. 6 is a cross-sectional view of the dispensing device along the line VI-VI shown in FIG. 5;

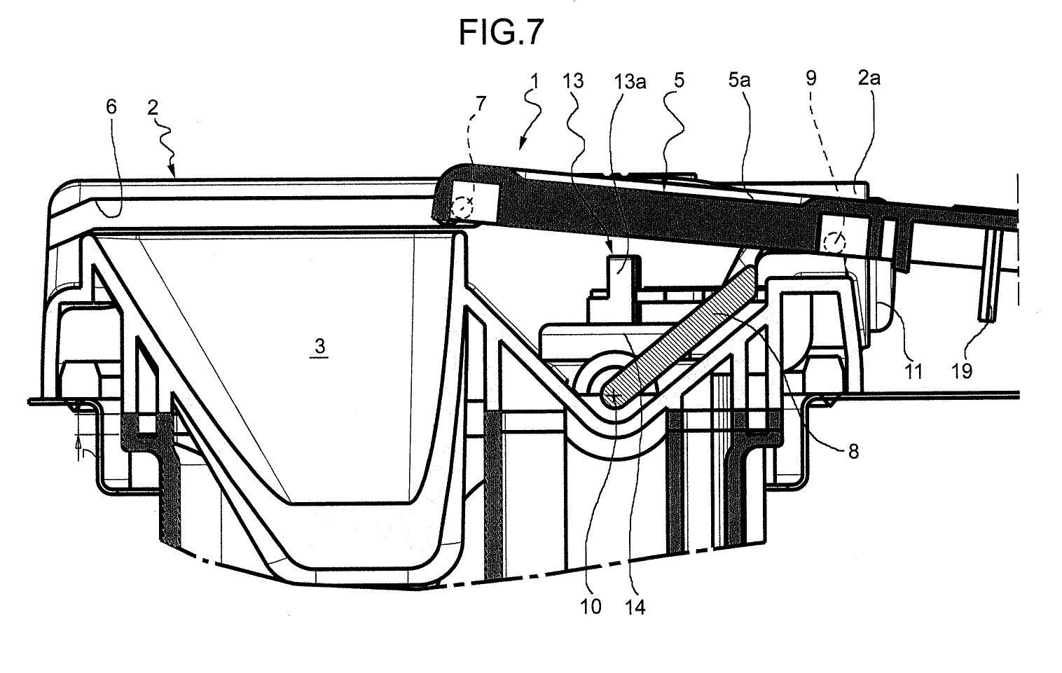

FIG. 7 is a cross-sectional view of the dispensing device along the line VII-VII shown in FIG. 1;

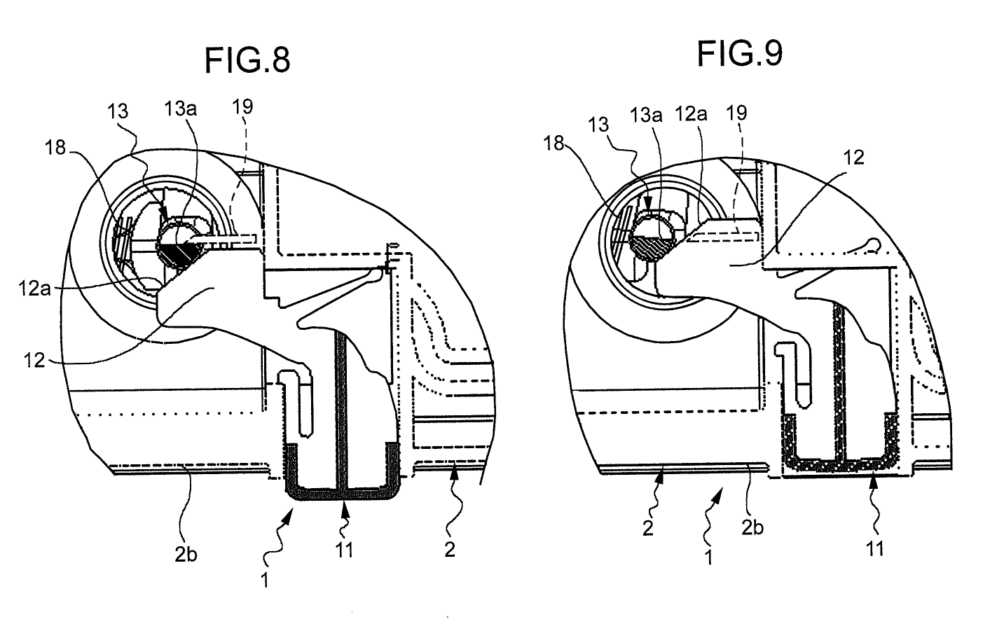

FIG. 8 is a partial top plan view cross-sectioned along a horizontal plane of a manual opening mechanism with which the dispensing device according to the preceding figures is provided and which is shown in a first operating condition;

FIG. 9 shows a view similar to that shown in FIG. 8, but showing the manual opening mechanism in a second operating condition;

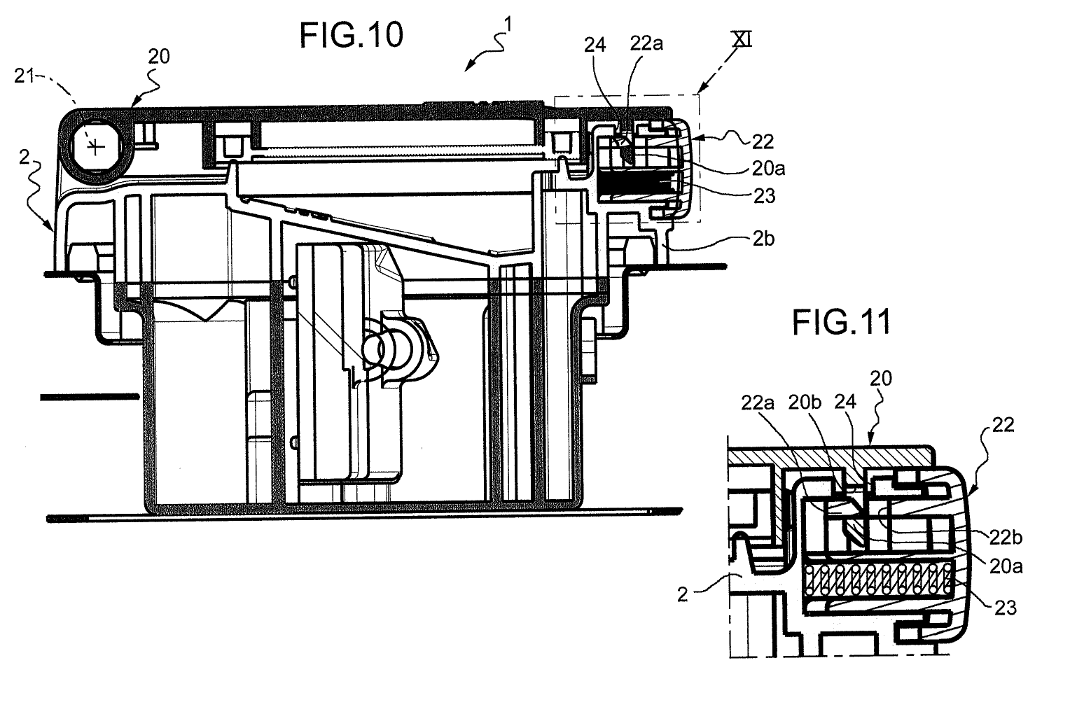

FIG. 10 is a cross-sectional view of the dispensing device along the line X-X shown in FIG. 1; and

FIG. 11 is a view, on a larger scale, of the boxed zone indicated by XI in FIG. 10.

In the drawings 1 denotes overall an example of embodiment of a dispensing device according to the invention suitable for dispensing a washing agent (or detergent) and—advantageously—also a rinsing (or brightening) agent for a dishwashing machine.

The dispensing device 1 according to FIGS. 1 to 10 comprises a stationary body 2, for example made of moulded plastic, which is intended to be connected (in a manner known per se and not shown) to the door of the dishwashing machine on the side directed during operation towards the washing chamber of this dishwashing machine.

With reference to FIGS. 1 to 9, the method for filling the dispensing device 1 with the washing agent will now be described.

A recessed receptacle 3, essentially in the form of a tray, which has an opening indicated by 4 is defined in the body 2. The receptacle 3 is intended to receive a quantity of washing agent, such as a powder detergent or a liquid detergent or a solid washing agent in the form of “soap bar” or tablet.

The device 1 comprises a movable lid 5 which is associated with the receptacle 3 and is connected to the stationary body 2. The movable lid 5 is displaceable in a manner constrained to the stationary body 2 between a closed position (FIGS. 1 and 4) and an open position (FIGS. 2 and 7), where it sealingly closes and opens the mouth 4 of the receptacle 3, respectively.

The method of joining together the movable lid 5 and the stationary body 2 will now be described. As will be clear to a person skilled in the art, this joining method is shown purely by way of example in that the principle of the invention may be extended also to different types of connection between the movable lid and the stationary body of a dispensing device.

With reference in particular to FIGS. 2 to 7, in the example of embodiment shown, the movable lid 5 is mounted slidably between two facing and parallel shoulders or lateral edges 2a which are provided with respective facing and substantially straight guiding grooves 6 close to two opposite sides of the mouth 4 of the receptacle 3.

With reference in particular to FIGS. 4, 5 and 7, the movable lid 5 has a first portion 5a provided on opposite sides with respective pins 7 which engage slidably inside the guiding grooves 6 of the stationary body 2. Owing to the engagement of these pins 7 inside the guiding grooves 6, the movable lid 5 can be pivoted relative to the stationary body 2 about a movable axis (i.e. the axis of its pins 7) which is essentially parallel to the mouth 4 of the receptacle 3 and displaceable along the guiding grooves 6.

The movable lid 5 also has a second portion 5b which is connected to a crank member 8 (FIGS. 4 to 7) substantially in a manner hinged about a first fixed axis parallel to the axis of the pins 7 and denoted by 9 in FIGS. 4 and 5.

As can be seen in FIGS. 4, 5 and 7, the crank member 8 is in turn hinged with the stationary body 2 about a second fixed axis 10 which is parallel to the axes 7 and 9 defined above.

Relative to the plane defined by the axes 7 and 9, the second fixed axis 10 is situated on the same side where the receptacle 3 for the detergent is situated.

The sequence shown in FIGS. 4, 5 and 7 illustrates the movement of the lid 5 from the closed position of the receptacle 3 into the completely open position thereof.

Overall, the lid 5 and the associated hinged member 8 form a crank mechanism of the first order or connecting rod-crank system. When passing from the closed position into the open position, the lid 5 follows a path along which it projects by quite a small amount from the plane in which it is situated in the closed position and open position.

Conveniently, the end portion 5b of the lid 5, opposite the portion 5a, has a curved and externally convex shape so as to limit the amount by which this lid projects transversely in the intermediate positions between the end positions of its working travel path.

In a manner not shown, a resilient return member, such as a spring, is associated with the crank member 8, said return member tending to cause the latter to pivot towards the position which it assumes when the movable lid 5 is in the completely open position (FIG. 7). This return spring may be, for example, a torsion spring or so-called needle spring mounted around the axis 10.

When the movable lid 5 is situated in the closed position (FIG. 4), a first retaining apparatus, which will be described below, keeps it in this position against the action of the return spring 10 which would tend to bring it back into the open position.

The dispensing device 1 comprises a first operating member 11, for example a pushbutton, situated on the side 2b of the stationary body 2 which during operation of the dishwashing machine is directed upwards.

The first operating pushbutton or member 11 is of the monostable type, slidable between inner walls of the stationary body 2 and designed to be operated by means of the pressure applied by a user so as to move from a stable extracted position (FIGS. 1 to 8) into an unstable retracted position (FIG. 9). As can be seen more clearly in FIGS. 3, 8 and 9, this first operating pushbutton 11 comprises a shaped end lug 12 projecting inside the stationary body 2 and having an inclined portion 12a which interacts with the first retaining apparatus.

With reference in particular to FIGS. 6, 8 and 9, the first retaining apparatus will now be described. It comprises an elongated rocker member 13 suspended inside the stationary body 2 by means of engagement with an elastomer membrane 14.

The rocker member 13 has an end 13a, at the apex, with a semi-cylindrical shape, a narrow intermediate section 13b with a cylindrical shape and a hollow terminal section 13c. The curved surface of the apex end 13a presses against—and co-operates with—the inclined portion 12a of the shaped end lug 12 of the pushbutton 11.

With reference in particular to FIG. 6, the elastomer membrane 14 of the first retaining apparatus has a thickened peripheral rim 14a and a substantially cup-shaped middle portion 14b which terminates in an inner annular portion 14c. The elastomer membrane 14 is fixed inside the stationary body 2 by means of the thickened peripheral rim 14a which is gripped by walls of a circular channel 15 formed in inner walls of the stationary body 2.

The rocker member 13 is engaged with the elastomer membrane 14 in the region of the inner annular portion 14c which embraces the narrow middle section 13b. In this way the elastomer membrane 14 allows the rocker member 13 to “float” inside the stationary body 2. By way of example, this type of connection may be provided by co-moulding the rocker member 13 with the elastomer membrane 14.

Therefore, owing to the connection with the elastomer membrane 14, the rocker member 13 may pivot inside the stationary body 2 with respect to a longitudinal pivoting axis 16. As can be understood from FIG. 6, the hollow terminal section 13c of the rocker member has a recess 17 which receives a first resilient recall member 18, such as a tensile spring, tending to bring the rocker member 13 back into alignment with the pivoting axis 16. The first resilient recall member 18, pressing on one side against the hollow terminal section 13c of the rocker member 13 and on the other side against an inner wall of the stationary body 2, also performs the function of limiting rotation of the rocker member 13 about its pivoting axis 16, constraining it so as to perform a substantially pivoting movement.

With reference to FIGS. 4 to 9, the dispensing device 1 includes a wedge-shaped projection 19 projecting from the second portion 5b of the movable lid 5 and directed towards the inside of the stationary body 2. Furthermore, the wedge-shaped projection 19 co-operates with the apex end 13a of the rocker member 13 in the manner which will now be described.

In FIG. 4 the device 1 is shown with the movable lid 5 in the closed position. The first retaining apparatus is shown there in an activated configuration, where it locks the movable lid 5 in the closed position.

As can be seen in FIG. 8, in the activated configuration, the wedge-shaped projection 19 of the movable lid is pressed against the flat portion of the apex end 13a of the rocker member 13. Consequently, the movable lid 5, which the crank member 8 biased by the associated return spring would tend to bring back into the open position, remains locked in the closed position.

In FIG. 5, the device is shown with the movable lid 5 in a partially open position. This condition arises following pressing of the pushbutton 11 by a user, resulting in its displacement from the extracted position (FIG. 8) into the retracted position (FIG. 9). In this way, the end lug 12 moves towards the inside of the stationary body 2 and its inclined portion 12a pushes the curved portion of the apex end 13a towards an eccentric position with respect to the pivoting axis 16. This results in a pivoting movement of the rocker member 13, which moves from the aligned position (FIGS. 6 and 8) into an inclined position (FIG. 9) with respect to the pivoting axis 16.

When the rocker member 13 is in the inclined position, the wedge-shaped projection 19 no longer makes contact with the apex end 13a and therefore the first retaining apparatus assumes a deactivated configuration, where it frees the movable lid 5. In fact, in this configuration the action of the crank member 8 is no longer opposed and the movable lid 5 is free to move towards the open position shown in FIG. 7. Immediately after the first operating pushbutton 11 has been pressed by the user, the first resilient recall member 18 pushes the hollow terminal section 13c so as to bring the rocker member 13 back into the aligned position when the wedge-shaped projection 19 has now passed beyond the apex end 13a during displacement of the movable lid 5.

The return movement of the movable lid 5 from the open position into the closed position is performed by a user who, after introducing a quantity of washing agent into the receptacle 3, slides the movable lid 5 towards the closed position, until it engages with the associated first retaining apparatus. This occurs owing to interference of the inclined surface of the wedge-shaped projection 19 against the curved portion of the apex end 13a, which allows the rocker member 13 to be pushed from the aligned position into the inclined position, until this wedge-shaped projection 19 passes beyond this apex end 13a. In this way the first resilient recall member 18 is free to bring the rocker member 13 back into the aligned position, such that the first retaining apparatus is again situated in the activated configuration shown in FIG. 8, namely where the wedge-shaped projection 19 makes contact with the apex end 13a.

During an operating cycle of the machine with which the device 1 is associated, an electrically operated actuator (not shown), such as a solenoid actuator or the like, causes by means of kinematic mechanisms known per se (not shown) the disengagement of the first retaining apparatus from the lid 5, so that the latter passes from the closed position into the open position of the receptacle 3 under the action of the associated recall spring.

The structure of the dispensing device 1 allows improved access to the movable lid 5 and to the first operating member 11 by a user wishing to introduce the washing agent. From an operational point of view, the user is able to operate the first pushbutton 11 even when the door of the dishwashing machine is not completely open, namely is arranged in a horizontal position. In fact, he/she is able to press the first pushbutton 11 even after only slightly inclining the door with respect to its vertical closed position. After pressing the pushbutton 11, the user may also easily access the mouth 4 of the receptacle 3 so as to fill the dispensing device 1 with the desired quantity of washing agent. Finally, he/she must only push and manually slide the movable lid 5 into its closed position where it is automatically locked by the first retaining apparatus.

With reference to FIGS. 1 and 10, the method of filling the dispensing device 1 with the rinsing agent will now be described.

The body 2 has a second lid 20 intended to close a second mouth (not shown) of a second receptacle (not shown in the figures) intended to receive a quantity of rinsing agent.

As can be seen in FIG. 10, the second lid 20 is hinged about a hinging axis 21 associated with a return spring (not visible) tending to cause it to pivot from a closed position into a completely open position (not shown).

The device 1 comprises a second operating pushbutton or member 22 located on the same side 2b of the stationary body 2 on which the first operating pushbutton 11 is arranged. Advantageously the second operating pushbutton 22 is also of the monostable type, designed to be operated by means of the pressure applied by a user, so as to pass from an extracted stable position (FIGS. 1 to 3 and 10) into a retracted unstable position (not shown).

The second pushbutton 22 is associated with a second resilient recall member 23 intended to push it towards the extracted position.

With reference to the enlarged view shown in 11, the second lid 20 comprises a first engaging tooth 20a projecting from it towards the inside of the stationary body 2. The dispensing device 1 comprises a second retaining apparatus comprising a second engaging tooth 22a formed on the second operating pushbutton 22.

In the closed position of the second lid 20 the first engaging tooth 20a is situated in an engaged position, namely it passes through an opening 24 formed in the stationary body 2 so as to then engage with the second engaging tooth 22a. In short, the first engaging tooth 20a passes through a first hole 22 formed in the side surface of the second operating pushbutton 22, adjacent to the second engaging tooth 22a. The latter passes through a second hole 20b formed in a middle portion of the first tooth 20a. The engagement between the first and second engaging teeth 20a and 22a (which corresponds to the engaged position and the activated configuration of the second retaining apparatus) prevents the second lid 20 from moving into the open position owing to the action of the return spring associated with it.

During operation thereof, the second pushbutton 22 moves into the retracted position so that the second engaging tooth 22a frees the second hole 20b and the first engaging tooth 20a is in turn aligned with the first hole 22b (which corresponds to a disengaged position for the second engaging tooth 22a and to the deactivated configuration of the second retaining apparatus). Consequently, owing to the action of the return spring of the second lid 20, the first engaging tooth 20a passes through the first hole 22b and the opening 23. In this way of the second lid 20 may move into the open position without being hindered. In the meantime, the second resilient recall member 23 repositions the second pushbutton 30 in the initial extracted position.

Closing of the second lid 20 is performed manually by the action of a user who pushes rotationally this second lid 20 again into the closed position (FIGS. 10 and 11). During this action, the first engaging tooth 20a passes initially through the opening 24 of the stationary body 2 and presses against the second engaging tooth 22a. Subsequently, owing to the interference between matchingly inclined portions of the engaging teeth 28a, 30a, the first engaging tooth 20a may initially push away the second engaging tooth 22a until it passes beyond it. Following which, the second resilient recall member 23 may cause the return movement of the second engaging tooth 22a into the starting position since the latter no longer encounters the resistance of the first engaging tooth 20a. Therefore, the second engaging tooth 22a may move and pass through the second hole 20b of the second operating pushbutton 20 such that the first and second teeth 20a and 22a are again respectively engaged in contact with each other in the activated configuration shown in FIG. 11.

Obviously the comments made above in connection with the improved accessibility of the lid 5 and the first pushbutton 11 for a user wishing to introduce the washing agent are equally applicable also to the mechanism of the second lid 20 and the second operating pushbutton 22.

In the above detailed description an embodiment of the dispensing device of the combined type for washing agent and rinsing agent has been described and illustrated. However, as will be clear to a person skilled in the art, the principle of the invention may also be applied to a dispensing device which envisages the distribution of the washing agent only or the rinsing agent only.

Obviously, without affecting the principle of the invention, the embodiments and constructional details may be widely varied with respect to that described and illustrated purely by way of a non-limiting example, without thereby departing from the scope of the invention as defined in the accompanying claims.

What claimed is:

1. Dispensing device for a washing and/or rinsing agent, in particular for a dishwashing machine,
said dispensing device comprising:
a stationary body designed to be integrally connected to the door of the dishwashing machine on the side directed during operation towards the washing chamber of said dishwashing machine;
at least one receptacle formed in the stationary body and intended to receive a quantity of a washing/rinsing agent and having a respective mouth intended to allow the introduction of said quantity of washing/rinsing agent by a user;
at least one movable lid associated with said at least one receptacle and displaceable in a manner constrained to the stationary body against the action of resilient return means from an open position into a closed position, where it opens and closes the mouth, respectively; and
at least one manual opening mechanism for said at least one movable lid, comprising
a retaining apparatus able to assume an activated configuration, in which it is designed to lock said at least one movable lid in the closed position, and a deactivated configuration, in which it is able to free said at least one movable lid, allowing it to pass from the closed position into the open position; and
an operating member of the monostable type located on the side of the stationary body which during operation of the dishwashing machine is directed upwards and displaceable against the action of first resilient recall means from a stable extracted position into an unstable retracted position, in which positions said operating member arranges the associated retaining apparatus in the activated configuration and in the deactivated configuration, respectively.

2. Dispensing device according to claim 1, in which the movable lid comprises a projection directed towards the stationary body and in which the retaining apparatus cooperates with said projection.

3. Dispensing device according to claim 2, in which the retaining apparatus in the activated and deactivated configuration is respectively designed to come into contact with and free said projection so as to oppose and permit, respectively, the action of the resilient return means.

4. Dispensing device according to claim 3, in which the retaining apparatus comprises a rocker member which cooperates simultaneously with the operating member and with the projection of the movable lid and which is pivotable about a pivoting axis.

5. Dispensing device according to claim 4, in which the rocker member pivots against the action of the first resilient recall means
from a position aligned with said pivoting axis, where the retaining apparatus is in the activated configuration and said rocker member is designed to make contact against said projection of the movable lid,
into an inclined position, where the retaining apparatus is in the deactivated configuration and said rocker member is designed to free said projection of the movable lid.

6. Dispensing device according to claim 4, in which the rocker member is suspended inside the stationary body by means of an elastomer membrane arranged between said rocker member and said stationary body.

7. Dispensing device according to claim 3, in which the retaining apparatus comprises an engaging tooth which is provided with the operating member and which cooperates with the projection of the movable lid.

8. Dispensing device according to claim 7, in which the engaging tooth is displaceable integrally with the operating member against the action of the first resilient recall means
from an engaged position which corresponds to the extracted position of the operating member and where said engaging tooth is designed to engage with said projection of the movable lid,
into a disengaged position which corresponds to the retracted position of the operating member and where said engaging tooth is designed to disengage from said projection of the movable lid.

9. Dispensing device according to claim 1, in which the stationary body comprises:
a first receptacle and a second receptacle intended to receive a quantity of washing agent and rinsing agent, respectively;
a first and a second movable lid associated with the first receptacle and the second receptacle, respectively; and
a first and a second manual opening mechanism for the first and the second movable lids, respectively.

10. Dispensing device according to claim 9, in which the first manual opening mechanism is of the type defined according to claim 4 and the second manual opening mechanism is of the type defined according to claim 7.

11. Dispensing device according to claim 1, in which the said operating member (s) is/are of the pushbutton type.
